(19) United States
(12) Patent Application Publication
(10) Pub. No.: US 2023/0041239 A1
(43) Pub. Date: Feb. 9, 2023

(54) GRAFTING DEVICE

(71) Applicant: ELM INC., Minamisatsuma-shi, Kagoshima (JP)

(72) Inventors: Takakazu MIYAHARA, Minamisatsuma-shi (JP); Kengo WADA, Minamisatsuma-shi (JP); John Cedric Villanueva OBAG, Kagoshima-shi (JP); Daiki ITO, Minamisatsuma-shi (JP)

(73) Assignee: ELM INC., Minamisatsuma-shi, Kagoshima (JP)

(21) Appl. No.: 17/789,334

(22) PCT Filed: Nov. 9, 2020
(86) PCT No.: PCT/JP2020/041706

§ 371 Date: Jun. 27, 2022

(30) Foreign Application Priority Data
Dec. 27, 2019 (JP) 2019-238698

(51) Int. Cl. A01G 2/32; F16B 2/20; A01G 2/35

(52) U.S. Cl. CPC A01G 2/32; F16B 2/20; A01G 2/35

(57) ABSTRACT

A grafting device including a rootstock holding unit and a scion holding unit both provided in a main body and relatively movable in a predetermined direction, at least one of the rootstock holding unit and the scion holding unit includes: a hand module including: a grip portion configured to be openable and closable for gripping a stem of a plant; reciprocating portions an operating rod and a slide plate provided between the grip portion and the main body and capable of reciprocating; a motion converting portion configured to convert reciprocation of the reciprocating portion into an opening/closing motion of the grip portion; and a biasing means configured to bias the reciprocating portion in any one direction of the reciprocating movement; and a drive means provided in the main body and configured to drive the reciprocating portion in a direction opposite to a biasing direction by the biasing means.

### TECHNICAL FIELD

The present invention relates to a device for successively grafting a large number of seedlings.

### BACKGROUND ART

The grafting is a method in which stems of two plant bodies are cut, and a lower part (referred to as rootstock) of one plant body and an upper part (referred to as scion) of the other plant body are joined and fused at their cut surfaces to obtain a plant body having desired characteristics. For example, it has been performed for a long time that a plant body having an advantage of being resistant to a continuous cultivation disorder is used as a rootstock, and a plant body producing a flavorful fruit with a large yield is used as a scion to perform grafting, thereby obtaining a plant body having both advantages.

Work related to grafting has been conventionally performed entirely by human hands, but in recent years, a device for saving labor for work related to grafting has been developed (see, for example, Patent Literature 1 or Patent Literature 2).

### CITATION LIST

### Patent Literature

Patent Literature 1: JP H10-113071 A

Patent Literature 2: JP H08-149920 A

### SUMMARY OF INVENTION

### Technical Problem

Such a device often includes a mechanism for holding a scion, a mechanism for holding a rootstock, a mechanism for cutting each of the scion and the rootstock, a mechanism for moving the scion or the rootstock, or both and joining the scion and the rootstock at their respective cut surfaces, and a mechanism for attaching a clip-like fixture to a joint portion between the joined rootstock and the scion. This makes it possible to automatically perform all or part of the work related to grafting.

However, the conventional grafting device still has room for improvement in terms of maintainability or versatility.

The present invention has been made in view of the above points, and an object of the present invention is to provide a grafting device excellent in maintainability or versatility.

### Solution to Problem

A grafting device according to the present invention made to solve the above problem includes:

a rootstock holding unit and a scion holding unit both provided in a main body and relatively movable in a predetermined direction, wherein

at least one of the rootstock holding unit and the scion holding unit includes:
a hand module including:
   a1) a grip portion configured to be openable and closable for gripping a stem of a plant;
   a2) a reciprocating portion provided between the grip portion and the main body and capable of reciprocating;
   a3) a motion converting portion configured to convert reciprocation of the reciprocating portion into an opening/closing motion of the grip portion; and
   a4) a biasing means configured to bias the reciprocating portion in any one direction of the reciprocating movement; and
b) a drive means provided in the main body and configured to drive the reciprocating portion in a direction opposite to a biasing direction by the biasing means.

In the grafting device according to the present invention having the above configuration, the grip portion is normally closed (or normally opened) by the biasing means, and the grip portion can be opened (or closed) by driving the reciprocating portion by the drive means. Therefore, it is not necessary to fix the boundary (specifically, between the reciprocating portion and the drive means) between the hand module and the main body to each other by screwing or welding. As a result, the hand module can be easily attached to and detached from the main body, and maintenance such as cleaning, disinfection, or replacement of the hand module can be easily performed. It is also easy to prepare a plurality of hand modules having different grippable stem thicknesses, and to selectively use the hand modules to be attached to the main body according to the stem thicknesses of the rootstock and scion to be used for grafting. Accordingly, the present invention can be applied to plants of various sizes, and versatility of the grafting device is improved.

In the grafting device according to the present invention, it is preferable that the drive means is configured to press the reciprocating portion to drive the reciprocating portion in the direction opposite to the biasing direction by the biasing means.

In the grafting device according to the present invention, it is preferable that the hand. module is configured to be attracted and fixed to the main body by magnetic force.

Preferably, the grafting device according to the present invention further includes:

c) a clip attaching unit configured to attach a clip to a joint between a rootstock held by the rootstock holding unit and a scion held by the scion holding unit; and

d) a control unit configured to control operations of the rootstock holding unit, the scion holding unit, and the clip attaching unit, wherein

the clip attaching unit includes:
c1) a clip hand configured to clamp the clip, and open and close the clip;
c2) a clip hand opening/closing drive portion configured to open and close the clip hand; and
c3) a clip hand forward/backward chive portion configured to move the clip hand forward and backward, and

the control unit is configured to control the clip attaching unit, the rootstock holding unit, and the scion holding unit so as to create a grafted seedling by attaching the clip to a joint between a rootstock held by the rootstock holding unit and a scion held by the scion holding unit, and then to open the grip portion provided on at least one of the rootstock holding unit and the scion holding unit and to push out the grafted seedling with the clip hand.

According to such a configuration, the work of detaching the completed grafted seedling from the grafting device can be automatically performed, and the work efficiency of the grafting operation is improved.

Preferably, the grafting device according to the present invention further includes:

e) a grafted seedling accommodation portion configured to receive the grafted seedling pushed out by the clip hand, the grafted seedling accommodation portion including a box portion having an opening on at least one surface and a hinge portion, the grafted seedling accommodation portion being configured to take a standing posture in which the opening is directed upward and a lying posture in which the opening is directed forward by rotating the box portion about the hinge portion, wherein

the grafted seedling accommodation portion is configured to take the standing posture in a state where the grafted seedling is not accommodated, and to take the lying posture by a weight of the grafted seedling in a state where the grafted seedling is accommodated.

The grafting device according to the present invention may further include:

f) a detection means configured to detect a posture of the grafted seedling accommodation portion, wherein

the control unit is configured to perform control to start a grafting operation when the detection means detects that the grafted seedling accommodation portion takes the standing posture after once taking the lying posture.

Alternatively, the grafting device according to the present invention may include:

f) a detection means configured to detect a posture of the grafted seedling accommodation portion, wherein

the control unit is configured to perform control not to start the grafting operation until the detection means detects that the grafted seedling accommodation portion takes the standing posture after the detection means detects that the grafted seedling accommodation portion takes the lying posture.

### Advantageous Effects of Invention

According to the present invention, it is possible to provide a grafting device excellent in maintainability or versatility.

### BRIEF DESCRIPTION OF DRAWINGS

FIG. 1 is a perspective view illustrating a grafting device according to an embodiment of the present invention.

FIG. 2 is a perspective view illustrating a state in which the grafting device is viewed from obliquely above in front.

FIG. 3 is a block diagram illustrating a control and drive system of the grafting device.

FIG. 4 is a perspective view of a hand module.

FIG. 5 is an exploded perspective view of the hand module.

FIG. 6 is a plan view illustrating the hand module in a closed state.

FIG. 7 is a plan view illustrating the hand module in an open state.

FIG. 8 is a perspective view for explaining a method of attaching the hand module to a module attachment portion.

FIG. 9 is a perspective view illustrating a state in which the hand module and an opening/closing drive portion are viewed obliquely from below.

FIG. 10 is a bottom view illustrating the hand module and the opening/closing drive portion in the open state.

FIG. 11 is a bottom view illustrating the hand module and the opening/closing drive portion in the closed state.

FIG. 12 is a perspective view illustrating a configuration of a clip attaching unit.

FIG. 13 is a perspective view illustrating a clip in the closed state.

FIG. 14 is a perspective view illustrating a clip in the open state.

FIG. 15 is a plan view illustrating a state in which a stem of a seedling is disposed between left and right claw portions of a hand portion in the open state.

FIG. 16 is a plan view illustrating a state in which a stem of a seedling is gripped by the hand portion.

FIG. 17 is a front view schematically illustrating a state in which a stem of a seedling is held by the hand portion.

FIG. 18 is a flowchart illustrating an execution procedure of a grafting process.

FIG. 19 is a perspective view illustrating a state in which stems of scion seedlings and rootstock seedlings are cut by the grafting device.

FIG. 20 is a perspective view illustrating a state in which the clip is opened by the clip attaching unit.

FIG. 21 is a perspective view illustrating a state in which a clip is attached to a stem by the clip attaching unit.

FIG. 22 is a perspective view illustrating a state in which a rootstock holding unit is raised.

FIG. 23 is a side view for explaining a step of pushing out a grafted seedling by the clip attaching unit.

FIG. 24 is a partial cross-sectional view illustrating a configuration example of a grafting device including a grafted seedling accommodation packet.

FIG. 25 is a partial cross-sectional view illustrating a state in which the grafted seedling accommodation packet is opened in the configuration example.

### DESCRIPTION OF EMBODIMENTS

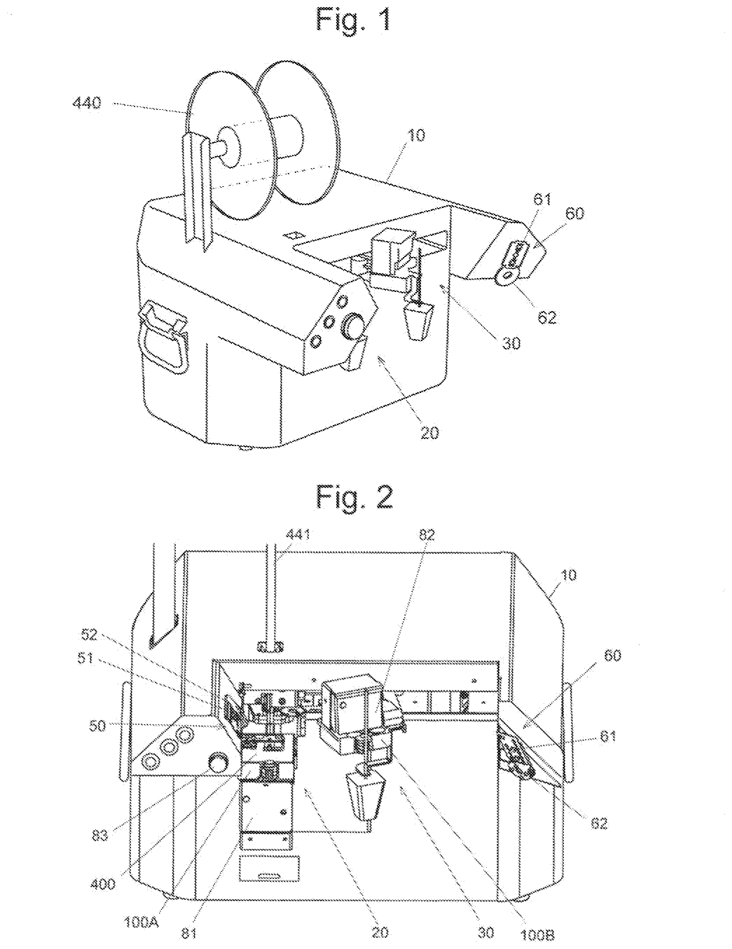

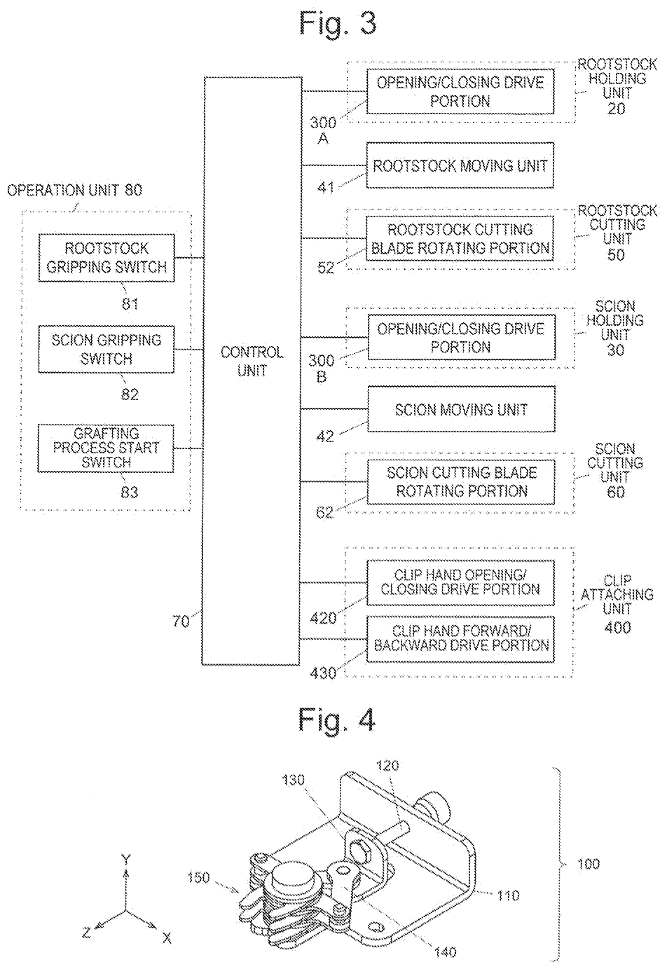

Hereinafter, embodiments for carrying out the present invention will be described with reference to the drawings. FIG. 1 is a view of a grafting device according to the present embodiment as viewed from obliquely left in front, and FIG. 2 is a view of the grafting device as viewed from obliquely above in front. FIG. 3 is a block diagram illustrating a configuration of a control and drive system of the grafting device. Note that, in the following description, front, rear, left, and right are defined with the front side in FIG. 2 as the front side and the back side as the rear side, the right side in FIG. 2 (that is, the right side when facing the front of the grafting device) as the right side, and the left side in FIG. 2 as the left side.

The grafting device includes a main body 10, a rootstock holding unit 20, a scion holding unit 30, a rootstock moving unit 41, a scion moving unit 42, a rootstock cutting unit 50, a scion cutting unit 60, a clip tube supplying unit 440, a clip attaching unit 400, a control unit 70, and an operation unit 80.

In the present embodiment, the basic configurations of the rootstock holding unit 20 and the scion holding unit 30 are common. Therefore, in the following description, when it is necessary to distinguish between each unit of the rootstock holding unit 20 and each unit of the scion holding unit 30, “A” is added to the end of the reference numeral of each unit of the rootstock holding unit 20, and “B” is added to the end of the reference numeral of each unit of the scion holding unit 30, and when it is not necessary to distinguish between them, “A” or “B” is omitted from the end of the reference numeral.

Each of the rootstock holding unit 20 and the scion holding unit 30 includes a hand module 100, a module attachment portion 200, and an opening/closing drive portion 300 (corresponding to a drive means in the present invention).

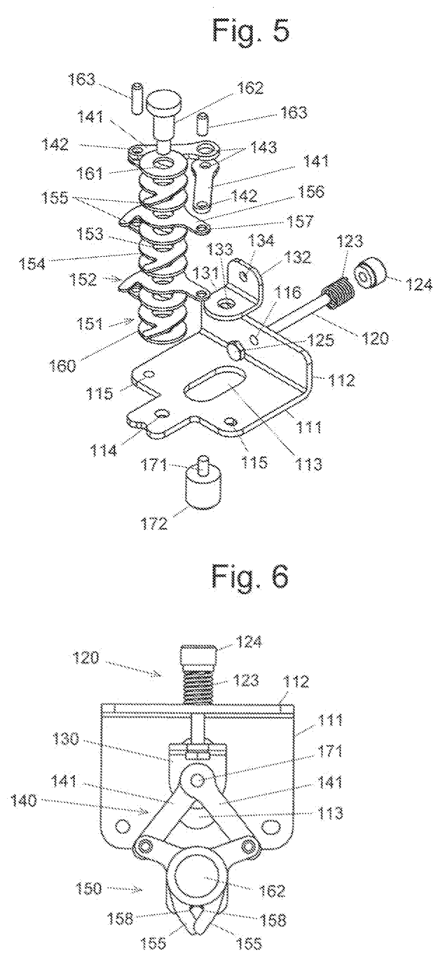

A configuration of the hand module 100 will be described with reference to FIGS. 4 to 7. In the description of the hand module 100, front, back, up, down, left, and right are defined with the arrowhead direction of the X axis as right, the arrowhead direction of the Y axis as upper, and the arrowhead direction of the Z axis as front in FIG. 4.

The hand module 100 includes a base plate 110, an operating rod 120, a slide plate 130, a motion converting portion 140, and a hand portion 150 (corresponding to a grip portion in the present invention).

The base plate 110 is a plate-like member made of a magnetic material such as iron, and includes a horizontal portion 111 and a vertical portion 112 erected behind the horizontal portion 111. A long hole-shaped guide hole 113 extending in the front-rear direction is provided at the center of the horizontal portion 111, and a first spindle insertion hole 114 which is a circular through hole is provided in front of the guide hole. A pair of positioning holes 115 are provided near the left and right front ends of the horizontal portion 111. The vertical portion 112 is provided with a first rod insertion hole 116 which is a circular through hole.

The operating rod 120 is a rod-shaped member having an outer diameter smaller than the first rod insertion hole 116, and is inserted into a coil spring 123 (corresponding to a biasing means in the present invention) having an outer diameter larger than the first rod insertion hole 116. Further, a fall prevention member 124 having an outer diameter larger than the inner diameter of the coil spring 123 is attached to the rear end of the operating rod 120.

The slide plate 130 is a member having a substantially L-shaped cross section and disposed on the base plate 110, and includes a first member 131 parallel to the horizontal portion 111 of the base plate 110 and a second member 132 erected at the rear end of the first member 131. A first guide pin insertion hole 133 is formed in the first member 131, and a second rod insertion hole 134 is formed in the second member 132.

The motion converting portion 140 includes two elongated link plates 141, and provided with a first attachment pin insertion hole 142 at the front end of each link plate 141 and a second guide pin insertion hole 143 at the rear end.

The hand portion 150 includes five clawed plates 151 and 152, six spacer plates 160, and one spindle 162. Each of the clawed plates 151 and 152 is a plate-like member including a circular base portion 154 having a second spindle insertion hole 153 at the center, one claw portion 155 protruding from the outer periphery of the base portion 154, and one operating protrusion 156 protruding from the outer periphery of the base portion 154. Each of the operating protrusions 156 is provided with a second attachment pin insertion hole 157. Each spacer plate 160 is a circular plate-like member having a third spindle insertion hole 161 in the center.

The five clawed plates 151 and 152 include three right clawed plates 151 configured such that the claw portion 155 is located on the front right side of the spindle 162 and the operating protrusion is located on the left side of the spindle, and two left clawed plates 152 configured such that the claw portion is located on the front left side of the spindle and the operating protrusion is located on the right side of the spindle. The claw portion 155 of the right clawed plate 151 has a V-shaped or U-shaped notch 158 on the left side, and the claw portion of the left clawed plate 152 has a similar notch 158 on the right side.

The hand module 100 is assembled in the following procedure, for example. First, the clawed plates 151 and 152 and the spacer plate 160 are alternately stacked. At this time, the right clawed plate 151 and the left clawed plate 152 are alternately arranged in the upward-downward direction. Subsequently, the spindle 162 is inserted from above into the second spindle insertion hole 153 provided in each of the clawed plates 151 and 152 and the third spindle insertion hole 161 provided in each of the spacer plates 160. Subsequently, the lower end of the spindle 162 is inserted into and fixed to the first spindle insertion hole 114 provided in the base plate 110. As a result, the hand portion 150 is formed, and the hand portion 150 is attached onto the base plate 110.

Next, the operating rod 120 is inserted into the coil spring 123, and the distal end of the operating rod 120 is further inserted into the first rod insertion hole 116 from the rear side of the vertical portion 112 of the base plate 110. Further, the distal end of the operating rod 120 is inserted into the second rod insertion hole 134 provided in the second member 132 of the slide plate 130, and then fixed to the slide plate 130 by a fixing member 125 including, for example, a nut.

Subsequently, from below the base plate 110, a guide pin 171 is inserted into the first guide pin insertion hole 133 provided in the first member 131 of the slide plate 130 through the guide hole 113, and the upper end of the guide pin 171 is inserted into the second guide pin insertion hole 143 provided in each of the two link plates 141. Note that a guide roller 172 having a larger diameter than the first guide pin insertion hole 133 and the second guide pin insertion hole 143 and a smaller diameter than the width of the guide hole 113 is provided at the lower end of the guide pin 171. By inserting the guide pin 171 into the guide hole 113, the first guide pin insertion hole 133, and the second guide pin insertion hole 143 as described above, the guide roller 172 is located in the guide hole 113. As a result of the above, the slide plate 130 is connected to the operating rod 120, and the slide plate 130 is attached onto the base plate 110 in a state of being slidable back and forth along the guide hole 113. In the present embodiment, the operating rod 120, the slide plate 130, the guide pin 171, and the guide roller 172 correspond to the reciprocating portion in the present invention.

Next, an attachment pin 163 is inserted into the second attachment pin insertion hole 157 provided in the operating protrusion 156 and the first attachment pin insertion hole 142 provided in one of the link plates 141 in a state where the distal end of the operating protrusion 156 of the right clawed plate 151 of the hand portion 150 and the distal end of the one link plate 141 are overlapped with each other. Similarly, the attachment pin 163 is inserted into the second attachment pin insertion hole 157 provided in the operating protrusion 156 and the first attachment pin insertion hole 142 provided in the other link plate 141 in a state where the distal end of the operating protrusion 156 of the left clawed plate 152 and the distal end of the other link plate 141 overlap each other. As a result, the hand portion 150 is connected to the slide plate 130 and the operating rod 120 via the motion converting portion 140, and the assembly of the hand module 100 is completed.

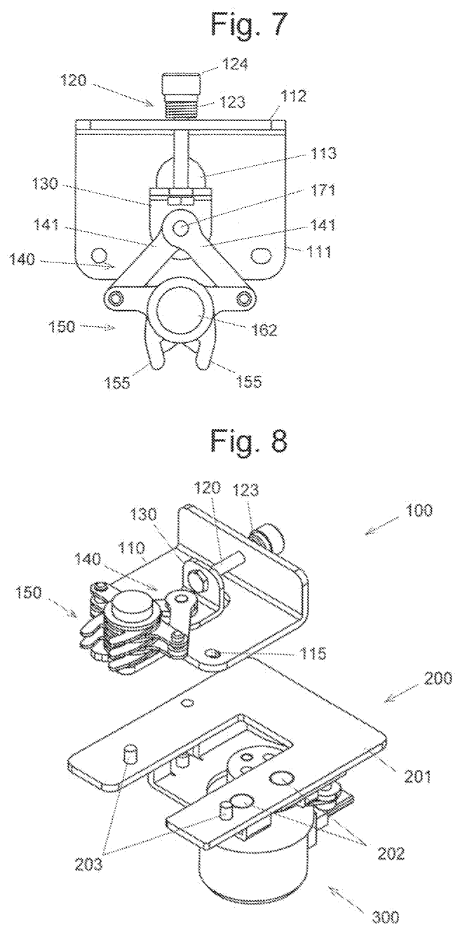

In the hand module 100 assembled as described above, the operating rod 120 is biased rearward with respect to the base plate 110 by the action of the coil spring 123. Therefore, in a state where no external force is applied to the guide roller 172, the slide plate 130 is pulled by the operating rod 120 to slide backward, and the rear end of the motion converting portion 140 is pulled backward by the slide plate 130. As a result, the two link plates 141 of the motion converting portion 140 rotate about the guide pin 171 in a direction in which the distal ends thereof approach each other, and a rotational force about the spindle 162 is applied to the operating protrusions 156 of the right clawed plate 151 and the left clawed plate 152. As a result, the right clawed plate 151 rotates clockwise in top view, and the left clawed plate 152 rotates counterclockwise in top view, so that the left and right claw portions 155 approach each other as illustrated in FIG. 6 Hereinafter, this state is referred to as “closed state” of the hand portion 150. In the closed state, the clawed plates 151 and 152 are configured such that the distal ends of the left and right claw portions 155 overlap each other in top view, and a slight gap is formed therebetween by the notches 158 of the left and right claw portions 155. On the other hand, when a forward force is applied to the guide roller 172, the slide plate 130 slides forward against the action of the coil spring 123, and the rear end of the motion converting portion 140 is pushed forward. As a result, the two link plates 141 rotate about the guide pin 171 in a direction in which the distal ends thereof are separated from each other, and a rotational force about the spindle 162 is applied to the operating protrusions 156 of the right clawed plate 151 and the loft clawed plate 152. As a result, the right clawed plate 151 rotates counterclockwise in top view, and the left clawed plate 152 rotates clockwise in top view, so that the left and right claw portions 155 are separated from each other as illustrated in FIG. 7. Hereinafter, this state is referred to as “open state” of the hand portion 150.

As illustrated in FIG. 8, the module attachment portion 200 is a member in which a magnet 202 and two positioning pins 203 are provided on an upper surface of an attachment plate 201 formed in a U shape. The positioning pins 203 are provided at positions corresponding to the positioning holes 115 provided in the base plate 110 of the hand module 100, these positioning pins 203 are inserted into the positioning holes 115, and the base plate 110 of the hand module 100 made of a magnetic material is attracted and fixed by the magnet 202, so that the hand module 100 can be detachably attached to the module attachment portion 200.

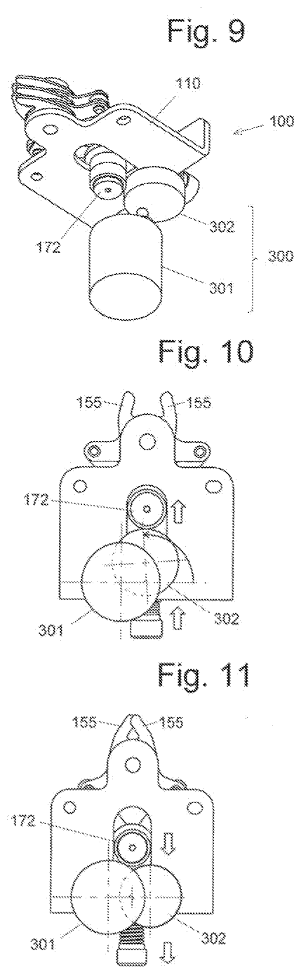

As illustrated in FIG. 9, the opening/closing drive portion 300 includes a motor 301 and a cam 302 attached to an output shaft of the motor 301. In FIG. 9, illustration of the module attachment portion 200 is omitted for simplification. As the motor 301 rotates, the cam 302 periodically comes into contact with the guide roller 172 provided in the hand module 100 or does not come into contact with the guide roller. When the cam 302 abuts on the guide roller 172, as illustrated in FIG. 10, the guide roller 172 is pushed by the cam 302 and moves forward along the guide hole 113, and accordingly, the operating rod 120 moves forward against the force of the coil spring 123 and the hand portion 150 becomes in the open state. On the other hand, in a state where the cam 302 does not abut on the guide roller, as illustrated in FIG. 11, the operating rod 120 moves backward by the action of the coil spring 123, and the hand portion 150 becomes in the closed state.

However, the configuration of the opening/closing drive portion 300 is not limited to the above, and may be any configuration as long as a forward force can be applied to the operating rod. For example, the opening/closing drive portion 300 may be configured to abut on the rear end of the operating rod 120 to push the operating rod forward. The opening/closing drive portion 300 is not limited to one including the motor and the cam as described above, and may be configured to convert the rotation of the motor into reciprocation by another rotation/linear motion conversion mechanism (a rack-and-pinion mechanism, a feed screw mechanism, a slider crank mechanism, or the like). As the opening/closing drive portion 300, a drive device that generates power in a linear direction such as a linear motor or a power cylinder (such as a hydraulic cylinder or an air cylinder) may be used.

As described above, since the opening/closing drive portion 300 opens the hand portion 150 by pressing a part (the guide roller in the above example) of the hand module 100 forward, the hand module 100 and the opening/closing drive portion 300 are not fixed to each other. The hand module 100 is held by the module attachment portion 200 by the magnet 202. Therefore, in the grafting device according to the present embodiment, the hand module 100 can be easily attached and detached according to cleaning, disinfection, change of a target plant, or the like. The module attachment portion 200 and the hand module 100 may be configured to be engaged with each other by a predetermined engaging means, for example, instead of being attracted and fixed to each other by the magnet as described above.

A module attachment portion 200A of the rootstock holding unit 20 is attached to the rootstock moving unit 41 provided on the left side of the front surface of the main body 10. The rootstock moving unit 41 moves the module attachment portion 200 of the rootstock holding unit 20 in the upward-downward direction, and includes, for example, a motor and a rotation/linear motion conversion mechanism that converts rotation of the motor into movement in the upward-downward direction.

A module attachment portion 200B of the scion holding unit 30 is attached to the scion moving unit 42 provided on the front surface of the main body 10. The scion moving unit 42 moves the module attachment portion 200 of the scion holding unit 30 in the left-right direction, and includes, for example, a motor and a rotation/linear motion conversion portion that converts the rotation of the motor into movement in the left-right direction.

The rootstock cutting unit 50 for cutting a rootstock is provided at the left end of the front surface of the main body 10, and the scion cutting unit 60 for cutting a scion is provided at the right end of the front surface of the main body 10. The rootstock cutting unit 50 includes a rootstock cutting blade 51 formed of a razor or the like, and a rootstock cutting blade rotating portion 52 that rotates the rootstock cutting blade 51. Similarly, the scion cutting unit 60 includes a scion cutting blade 61 formed of a razor or the like, and a scion cutting blade rotating portion 62 that rotates the scion cutting blade 61.

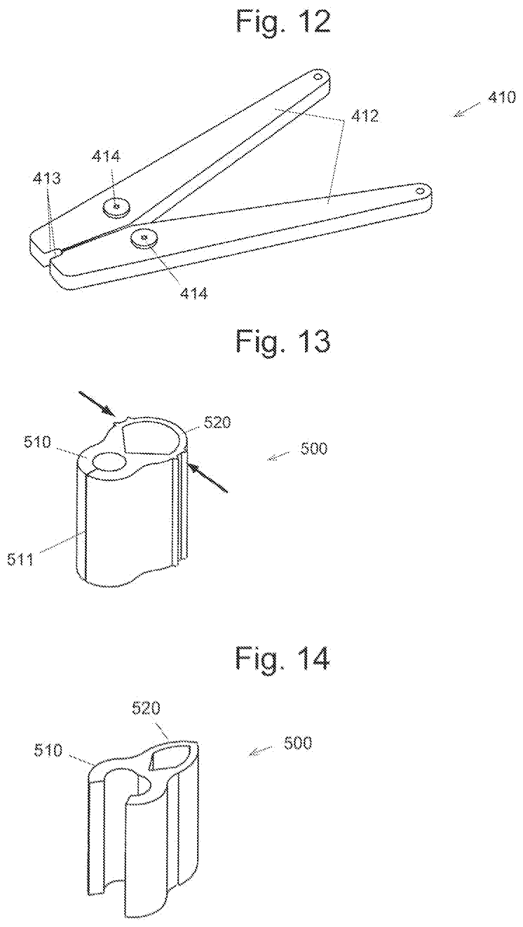

The clip attaching unit 400 attaches a fixing clip to a joint between a rootstock and a scion, and includes a clip hand 410 that grips the clip, a clip hand opening/closing drive portion 420 that opens and closes the clip hand 410, and a clip hand forward/backward drive portion 430 that moves the clip hand 410 forward and backward. As illustrated in FIG. 12, the clip hand 410 includes two arms 412 each of which rotates about a hinge 414. A recessed clip clamping portion 413 is provided at a position facing each other at a distal end of each arm 412, and the rear end of each arm 412 is connected to the clip hand opening/closing drive portion 420 including a motor or the like. When the clip hand opening/closing drive portion 420 moves the rear ends of the two arms 412 of the clip hand 410 toward each other, the distal ends of the two arms 412 are separated (that is, the clip hand 410 is opened). On the other hand, when the clip hand opening/closing drive portion 420 moves the rear ends of the two arms 412 of the clip hand 410 in a direction away from each other, the distal ends of the two arms 412 come into contact with each other (that is, the clip hand 410 is closed). A coil spring may be stretched between the rear ends of the arms 412 of the clip hand 410 so that the clip hand 410 is always opened by the action of the coil spring, and the clip hand opening/closing drive portion 420 may perform only the closing operation of the arms 412.

FIG. 13 illustrates the configuration of a clip 500 attached to the joint between the rootstock and the scion by the clip attaching unit 400. The clip 500 is made of a soft resin, and has a substantially 8-shaped cross section including a first pipe 510 extending in the axial direction thereof and a second pipe 520 parallel thereto. Hereinafter, the axial direction of the clip 500 is defined as the upward-downward direction, the side on which the first pipe 510 is located is defined as the front, and the side on which the second pipe 520 is located is defined as the rear, so that the front-rear direction and the upward-downward direction of the clip 500 are defined. A cut 511 is provided on the front surface of the first pipe 510 along the axial direction thereof, and the first pipe 510 is opened along the cut 511 as illustrated in FIG. 14 by squashing the peripheral surface of the second pipe 520 in a direction indicated by a thick arrow in FIG. 13. Such a clip 500 is formed by manufacturing a tube (hereinafter, referred to as clip tube 441 (FIG. 2)) having the same cross-sectional shape as the clip 500 in advance by extrusion molding and cutting the clip tube 441 by a predetermined length. The clip tube 441 is held in a state of being wound around the clip tube supplying unit 440 provided above the main body 10. Then, the dip tube is sequentially drawn out by a predetermined drawing mechanism (not illustrated) provided in the main body 10, cut to the predetermined length by a predetermined cutting mechanism (not illustrated) also provided in the main body 10, and then sent to the clip attaching unit 400.

The control unit 70 controls the operation of each unit according to the operation of a rootstock gripping switch 81, a scion gripping switch 82, and a grafting process start switch 83 by the user (operator who performs the grafting operation). The function of the control unit 70 may be realized in a so-called software manner by causing a CPU to execute a predetermined program or may be configured in a hardware manner by a circuit or the like. In addition, both may be combined.

In the present embodiment, the grafting process start switch 83 is provided in the main body 10, and the rootstock gripping switch 81 and the scion gripping switch 82 are provided in the rootstock holding unit 20 and the scion holding unit 30, respectively. However, all of these switches may be provided in the main body 10.

Hereinafter, a procedure of the grafting operation using the grafting device according to the present embodiment will be described. At the start of the grafting operation, both the rootstock holding unit 20 and the scion holding unit 30 are located at the initial positions illustrated in FIG. 2, and both the hand portion 150 of a hand module 100A provided in the rootstock holding unit 20 and the hand portion 150 of a hand module 100B provided in the scion holding unit 30 are in the open state.

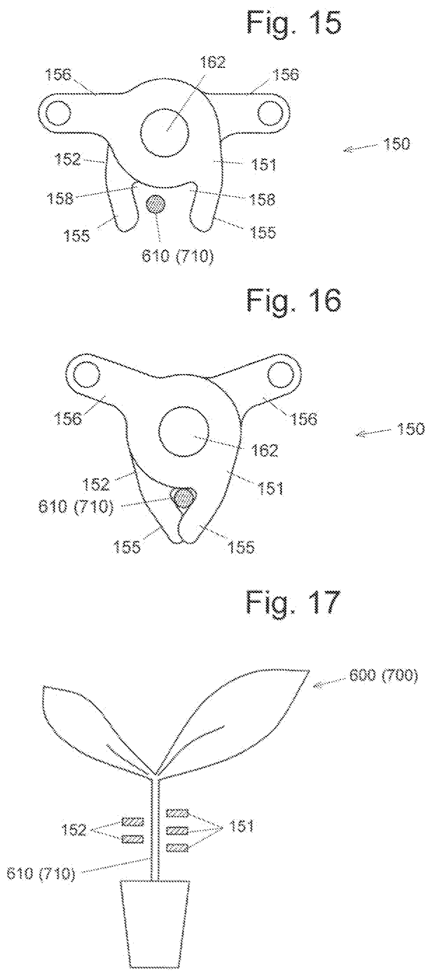

First, the user disposes a scion seedling 700 near the hand module 100B of the scion holding unit 30. Then, the scion gripping switch 82 is pressed in a state where a stem 710 of the scion seedling 700 is positioned between the left and right claw portions 155 of the hand portion 150 as illustrated in FIG. 15. As a result, the opening/closing drive portion 300B of the scion holding unit 30 operates under the control of the control unit 70 to bring the hand module 100 to the closed state. As a result, as illustrated in FIG. 16, the stem 710 of the scion seedling 700 is gripped by the hand portion 150. At this time, since the closing force of the hand portion 150 is caused by the action of the coil spring 123, the holding force does not greatly change depending on the thickness of the stem 710. As described above, the V-shaped or U-shaped notch 158 is formed between the left and right claw portions 155, and the space surrounded by the notches 158 of the left and right claw portions 155 becomes narrower as the left and right claw portions 155 approach each other. Therefore, even if the user does not accurately dispose the stem 710 of the seedling at the center between the left and right claw portions 155, the stem 710 is automatically centered as the hand portion 150 is closed. Since the hand portion 150 includes the plurality of clawed plates 151 and 152 stacked in the upward-downward direction, the stem 710 can be gripped straight as illustrated in FIG. 17, and it is possible to prevent problems such as gripping of the seedling in an inclined state.

After the scion seedling 700 is set as described above, the rootstock seedling 600 is gripped by the hand module 100A of the rootstock holding unit 20 in the same manner. The gripping of the rootstock seedling 600 and the gripping of the scion seedling 700 may be performed in reverse order.

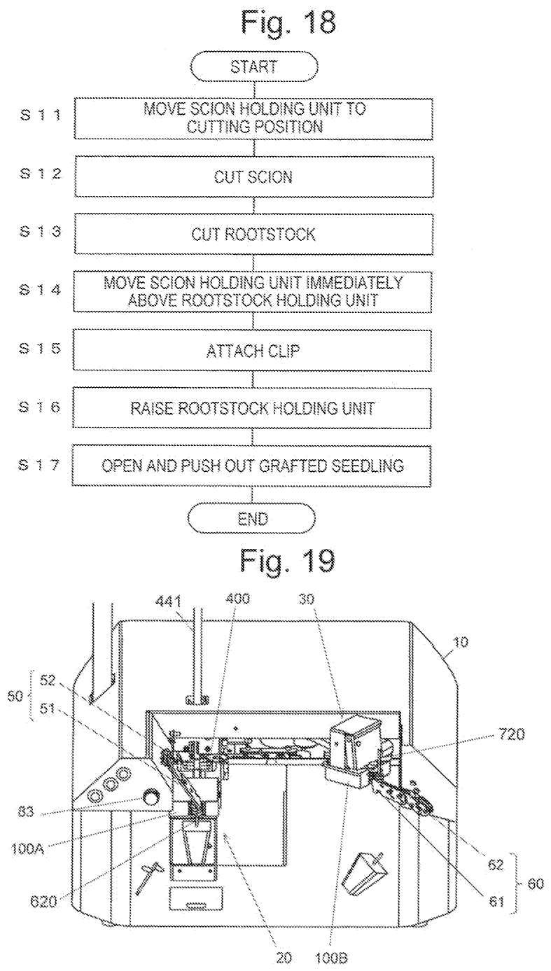

Subsequently, when the user presses the grafting process start switch 83, the control unit 70 controls each unit of the grafting device to execute the grafting process. Hereinafter, an execution procedure of the grafting process performed under the control of the control unit 70 after the pressing of the grafting process start switch 83 will be described with reference to a flowchart of FIG. 18.

The scion moving unit 42 moves the scion holding unit 30 to the cutting position at the right end of the main body 10 (Step S11), and the scion cutting blade 61 is rotated by the scion cutting blade rotating portion 62 provided in the scion cutting unit 60 to cut the stem 710 of the scion seedling 700 (Step S12). The rootstock cutting blade rotating portion 52 provided in the rootstock cutting unit 50 rotates the rootstock cutting blade 51 to cut the stem 610 of the rootstock seedling 600 (Step S13). At this time, since the rootstock seedling 600 and the scion seedling 700 are held at accurate positions by the centering action of the hand portions 150 provided in the rootstock holding unit 20 and the scion holding unit 30, respectively, the stems 610 and 710 can be accurately cut at predetermined positions and angles. The cutting of the scion seedling 700 and the cutting of the rootstock seedling 600 may be performed in the order opposite to the above order, or may be performed simultaneously. As a result of the above, the upper part of the rootstock seedling 600 and the lower part of the scion seedling 700 are cut off, and the lower part of the rootstock seedling 600 (hereinafter, referred to as rootstock 620) is gripped by the rootstock holding unit 20, and the upper part of the scion seedling 700 (hereinafter, referred to as scion 720) is gripped by the scion holding unit 30 (FIG. 19).

When the cutting of the scion seedling 700 and the rootstock seedling 600 is completed as described above, the scion moving unit 42 moves the scion holding unit 30 leftward from the cutting position and stops the scion holding unit 30 immediately above the rootstock holding unit 20 under the control of the control unit 70 (Step S14). Also at this time, since the rootstock 620 and the scion 720 are held at accurate positions by the centering action of the hand portions 150 provided in the rootstock holding unit 20 and the scion holding unit 30, respectively, the cut surface of the scion 720 can be accurately positioned directly above the cut surface of the rootstock 620 by moving the scion holding unit 30 directly above the rootstock holding unit 20.

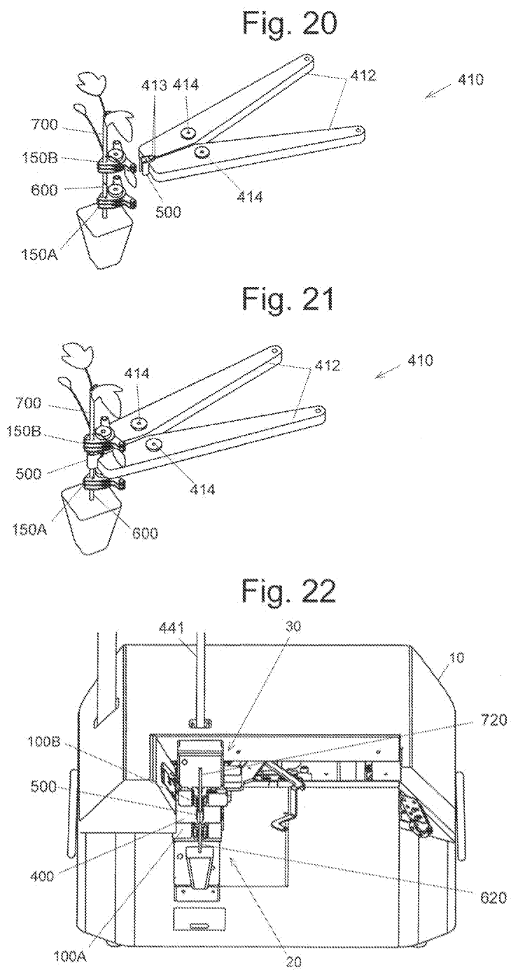

Next, the clip 500 is attached to the boundary between the stem 710 of the scion 720 and the stem 610 of the rootstock 620 by the clip attaching unit 400 (Step S15). The operation of the clip attaching unit 400 at this time will be described. First, the clip hand 410 is closed by the clip hand opening/closing drive portion 420 with the second pipe 520 of the clip 500 positioned at the distal end of the clip hand 410. As a result, as illustrated in FIG. 20, the clip 500 is clamped at the distal end of the clip hand 410, and the second pipe 520 of the clip 500 is squashed, so that the first pipe 510 is opened along the cut. Subsequently, the clip hand forward/backward drive portion 430 moves the clip hand 410 forward to position the stems 610 and 710 of the rootstock 620 and the scion 720 in the first pipe 510 of the clip 500. Subsequently, the clip hand opening/closing drive portion 420 opens the clip hand 410. As a result, the first pipe 510 of the clip 500 is closed, and the scion 720 and the rootstock 620 are fixed to each other by the clip 500 (FIG. 21). Thereafter, under the control of the control unit 70, the clip hand forward/backward drive portion 430 moves the clip hand 410 backward, and the clip hand opening/closing drive portion 420 closes the clip hand.

Thereafter, the rootstock moving unit 41 moves the rootstock 620 upward from the initial position by a predetermined distance to bring the cut surface of the rootstock 620 and the cut surface of the scion 720 into close contact with each other (Step S16, FIG. 22). As a result of the above a grafted seedling 800 obtained by grafting the rootstock 620 and the scion 720 is completed.

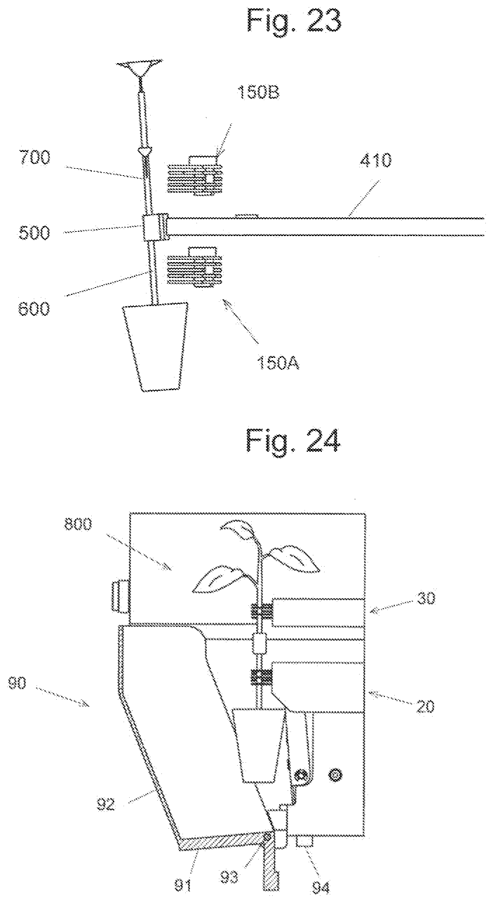

Thereafter, under the control of the control unit 70, the clip hand forward/backward drive portion 430 moves the clip hand 410 forward, and at the same time, opening/closing drive portions 300A and 300B of the rootstock holding unit 20 and the scion holding unit 30 open a hand portion 150A of the rootstock holding unit 20 and a hand portion 150B of the scion holding unit 30, respectively. As a result, as illustrated in FIG. 23, the grafted seedling 800 is released from the rootstock holding unit 20 and the scion holding unit 30, and the grafted seedling 800 is pushed forward by the clip hand 410 (Step S17). As described above, when the grafting operation is completed, the hand portion 150A of the rootstock holding unit 20 and the hand portion 150B of the scion holding unit 30 are opened, and the grafted seedling 800 is pushed forward by the clip attaching unit 400, whereby the grafted seedling 800 can be easily and reliably removed from the grafting device. Since the clip attaching unit 400 also serves as a mechanism for pushing out the grafted seedling 800, it is possible to suppress an increase in the number of parts and realize cost reduction.

Thereafter, the user houses the detached grafted seedling 800 in a tray or the like prepared in advance, sets the next rootstock seedling 600 and the next scion seedling 700 by repeating the above operation, and executes the grafting operation.

Although the embodiment of the present invention is described with specific examples, the grafting device according to the present invention is not limited to such an embodiment, and an appropriate change in the scope of the present invention is acceptable.

For example, in the above embodiment, the coil spring 123 is used as the biasing means according to the present invention, but the biasing means in the present invention may be any biasing unit as long as the biasing unit can bias the reciprocating portion (the operating rod 120 and the slide plate 130 in the above embodiment) in any one direction of the reciprocating movement, and for example, an elastic body (such as a leaf spring) other than the coil spring can be used. In the above embodiment, the reciprocating portion is pressed by the drive means (the opening/closing drive portion 300 in the above embodiment). However, the drive means in the present invention may be any unit as long as the reciprocating portion can be driven in a direction opposite to the biasing direction by the biasing means. For example, the reciprocating portion may be pulled by the drive means. The hand module of the present invention is not limited to the configuration in which the grip portion (the hand portion 150 in the above embodiment) is brought into the normally closed state by the action of the biasing means and the grip portion is brought into the opened state by pushing (or pulling) the reciprocating portion by the drive means as in the above embodiment, and conversely, may be configured such that the grip portion is brought into the normally opened state by the biasing means and the grip portion is brought into the closed state by pushing (or pulling) the reciprocating portion by the drive means.

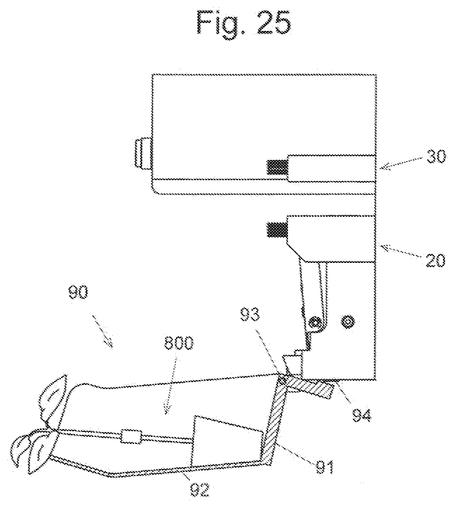

For example, the grafting device according to the present invention may further include a grafted seedling accommodation packet 90 (corresponding to a grafted seedling accommodation portion in the present invention) which temporarily accommodates the completed grafted seedling 800. FIGS. 24 and 25 illustrate a configuration example including such a grafted seedling accommodation packet 90. The grafted seedling accommodation packet 90 is a box-shaped member having at least a bottom surface portion 91 provided immediately below the rootstock holding unit 20 and a front surface portion 92 erected at a front end edge of the bottom surface portion 91, and having an opening portion at a position facing the bottom surface portion 91. A hinge 93 is provided on one side on the back side of the bottom surface portion 91, and when the grafted seedling 800 falls on the bottom surface portion 91, the weight of the grafted seedling causes the grafted seedling accommodation packet 90 to lie forward with the hinge 93 as the center, so that the grafted seedling accommodation packet is opened as illustrated in FIG. 25 (referred to as lying posture). When the user takes out the grafted seedling 800 from the grafted seedling accommodation packet 90, the grafted seedling accommodation packet 90 stands again by the action of a weight or a spring, and returns to a stand state (referred to as standing posture) as illustrated in FIG. 24. In this way, by adopting a configuration in which the grafted seedling accommodation packet 90 lies down while receiving the dropped grafted seedling 800, it is possible to alleviate the impact when the grafted seedling 800 falls and to minimize the damage caused on the seedling.

As described above, by providing the grafted seedling accommodation packet 90 for temporarily accommodating the completed grafted seedling 800, the user can set the scion seedling 700 and the rootstock seedling 600 to be used for the next grafting operation in the grafting device while putting the completed grafting seedling 800 on the tray or the like on delay and allowing the grafting seedling 800 to be accommodated in the grafted seedling accommodation packet 90. Thereafter, the user takes out the grafted seedling 800 from the grafted seedling accommodation packet 90, and then presses the grafting process start switch 83 to start the next grafting operation. Then, while the next grafting operation is being performed, the operation of arranging the above-mentioned grafted seedling 800 on a tray or the like is performed. As a result, the time required from the completion of the grafted seedling 800 to the start of the next grafting operation can he shortened, and the successive grafting operation can be performed more efficiently.

Further, it is preferable that the grafting device including such a grafted seedling accommodation packet 90 is provided with a detection means that detects whether the grafted seedling accommodation packet 90 is in the lying posture or in the standing posture, and the grafting operation is not performed (that is, some or all of the opening/closing drive portions 300A and 300B, the rootstock moving unit 41, the scion moving unit 42, the rootstock cutting blade rotating portion 52, the scion cutting blade rotating portion 62, the clip hand opening/closing drive portion 420, and the clip hand forward/backward drive portion 430 do not operate) while the grafted seedling accommodation packet 90 is in the lying posture (that is, during a period from when it is detected that the grafted seedling accommodation packet 90 takes the lying posture to when it is detected that the grafted seedling accommodation packet 90 takes the standing posture). As a result, the grafting device does not operate while the grafted seedling 800 is in the grafted seedling accommodation packet 90, so that the safety of the operation by the user can be enhanced.

Alternatively, instead of pressing the grafting process start switch 83, the grafting process illustrated in the flowchart of FIG. 18 may be automatically started when the detection means detects that the grafted seedling accommodation packet 90 has shifted from the lying posture to the standing posture. In this case, when the user sets the next scion seedling 700 and the next rootstock seedling 600 in the grafting device in a state in which the completed grafted seedling 800 is accommodated in the grafted seedling accommodation packet 90 and then takes out the grafted seedling 800 from the grafted seedling accommodation packet 90, the grafting process is started at the same time when the grafted seedling accommodation packet 90 automatically returns to the standing posture. As a result, the work efficiency of the successive grafting operation can be further enhanced.

As the detection means, for example, an optical sensor, a switch 94 configured not to be pressed when the grafted seedling accommodation packet 90 is in the lying posture but to be pressed when it is in the standing posture as illustrated in FIGS. 24 and 25 (alternatively, a switch is configured not to be pressed when the grafted seedling accommodation packet 90 is in the standing posture but to be pressed when the grafted seedling accommodation packet 90 is in the lying posture), or the like can be used.

### REFERENCE SIGNS LIST

10 . . . Main Body
20 . . . Rootstock Holding Unit
30 . . . Scion Holding Unit
50 . . . Rootstock Cutting Unit
60 . . . Scion Cutting Unit
100 . . . Hand Module
110 . . . Base Plate
113 . . . Guide Hole
120 . . . Operating Rod
123 . . . Coil Spring
130 . . . Slide Plate
140 . . . Motion Converting Portion
141 . . . Link Plate
150 . . . Hand Portion
151, 152 . . . Clawed Plate
155 . . . Claw Portion
171 . . . Guide Pin
172 . . . Guide Roller
70 . . . Control Unit
200 . . . Module Attachment Portion
201 . . . Plate
202 . . . Magnet
203 . . . Positioning Pin
300 . . . Opening/Closing Drive Portion
301 . . . Motor
302 . . . Cam
400 . . . Clip Attaching Unit
410 . . . Clip Hand
420 . . . Clip Hand Opening/Closing Drive Portion
430 . . . Clip Hand Forward/Backward Drive Portion
500 . . . Clip
90 . . . Grafted Seedling Accommodation Packet
94 . . . Switch

1-7. (canceled)

8. A grafting device comprising:
a rootstock holding unit and a scion holding unit both provided in a main body and relatively movable in a predetermined direction;
a clip attaching unit configured to attach a clip to a joint between a rootstock held by the rootstock holding unit and a scion held by the scion holding unit; and
a control unit configured to control operations of the rootstock holding unit, the scion holding unit, and the clip attaching unit, wherein
the clip attaching unit includes:
a clip hand configured to clamp the clip, and open and close the clip;
a clip hand opening/closing drive portion configured to open and close the clip hand; and
a clip hand forward/backward drive portion configured to move the clip hand forward and backward, and
the control unit is configured to control the clip attaching unit, the rootstock holding unit, and the scion holding unit so as to create a grafted seedling by attaching the clip to a joint between a rootstock held by the rootstock holding unit and a scion held by the scion holding unit, and then to open a grip portion, which is provided on at least one of the rootstock holding unit and the scion holding unit and is configured to be openable and closable for gripping a stem of a plant, and to push out the grafted seedling with the clip hand.

9. The grafting device according to claim 8, further comprising:
a grafted seedling accommodation portion configured to receive the grafted seedling pushed out by the clip hand, the grafted seedling accommodation portion including a box portion having an opening on at least one surface and a hinge portion, the grafted seedling accommodation portion being configured to take a standing posture in which the opening is directed upward and a lying posture in which the opening is directed forward by rotating the box portion about the hinge portion, wherein
the grafted seedling accommodation portion is configured to take the standing posture in a state where the grafted seedling is not accommodated, and to take the lying posture by a weight of the grafted seedling in a state where the grafted seedling is accommodated.

10. The grafting device according to claim 9, further comprising:
a detection means configured to detect a posture of the grafted seedling accommodation portion, wherein
the control unit is configured to perform control to start a grafting operation when the detection means detects that the grafted seedling accommodation portion takes the standing posture after once taking the lying posture.

11. The grafting device according to claim 9, further comprising:
a detection means configured to detect a posture of the grafted seedling accommodation portion, wherein
the control unit is configured to perform control not to start the grafting operation until the detection means detects that the grafted seedling accommodation portion takes the standing posture after the detection means detects that the grafted seedling accommodation portion takes the lying posture.

12. The grafting device according to claim 8, wherein at least one of the rootstock holding unit and the scion holding unit includes:
a hand module including:
a1) the grip portion;
a2) a reciprocating portion provided between the grip portion and the main body and capable of reciprocating;
a3) a motion converting portion configured to convert reciprocation of the reciprocating portion into an opening/closing motion of the grip portion; and
a4) a biasing means configured to bias the reciprocating portion in any one direction of the reciprocating movement; and
b) a drive means provided in the main body and configured to drive the reciprocating portion in a direction opposite to a biasing direction by the biasing means.

13. The grafting device according to claim 12, wherein the drive means is configured to press the reciprocating portion to drive the reciprocating portion in the direction opposite to the biasing direction by the biasing means.

14. The grafting device according to claim 12, wherein the hand module is configured to be attracted and fixed to the main body by magnetic force.
